(19) United States
(12) Patent Application Publication
(10) Pub. No.: US 2012/0074731 A1
(43) Pub. Date: Mar. 29, 2012

(54) FRONT-SIDE MEMBER STRUCTURE

(75) Inventor: Koji Yoshida, Numazu-shi (JP)

(73) Assignee: TOYOTA JIDOSHA KABUSHIKI KAISHA, Toyota-shi (JP)

(21) Appl. No.: 13/322,928

(22) PCT Filed: Mar. 16, 2010
(86) PCT No.: PCT/JP10/54419

§ 371 Date: Nov. 29, 2011

(51) Int. Cl. B62D 25/00

(52) U.S. Cl. 296/193.05

(57) ABSTRACT

An object of the invention is to provide a front side member structure that can improve yield strength against a moment generated due to a vehicle collision and the like.

A front side member structure according to the invention is provided at a lower portion of a vehicle so as to extend in a longitudinal direction of the vehicle and is used to form a frame of the vehicle. The front side member structure includes an under portion that extends in the longitudinal direction, and a kick portion that is provided at a front portion of the under portion and extends forward and upward. A front contour of the kick portion in the side view of the kick portion is inclined at an angle closer to a right angle than a rear contour of the kick portion in the side view of the kick portion. Accordingly, it is possible to reduce the cross section of a kick member at an upper portion of the kick member where a moment generated due to a vehicle collision and the like is small, and to increase the cross section of the kick member at a lower portion of the kick member where a generated moment is large. Therefore, it is possible to increase yield strength against a moment at a portion where a generated moment is large. As a result, it is possible to achieve the above-mentioned object.

### TECHNICAL FIELD

The present invention relates to a front side member structure that forms a frame of a vehicle.

### BACKGROUND ART

A vehicle body frame structure, which secures the strength of a frame while securing sufficient weld strength below a floor panel, has been examined hitherto. As this vehicle body frame structure, there is a vehicle body frame structure disclosed in, for example, Patent Literature 1. A side frame of this vehicle body frame structure is formed so as to be divided into a front side frame and a floor frame. The front side frame is provided in front of the floor frame, and a rear end portion of the front side frame and a front end portion of the floor frame are joined to each other while overlapping each other. In this side frame, deformation occurs at a joining portion where the front side frame and the floor frame are joined to each other when a moment is generated by a load that is input from the front of a vehicle at the time of a vehicle collision. Accordingly, in order to increase the strength of the joining portion, a reinforcing member is joined to the upper surface of the floor frame at the joining portion where the front side frame and the floor frame are joined to each other.

At the joining portion of the side frame of the vehicle body frame structure, the front side frame, the floor frame, and the reinforcing member form a frame. A floor panel is joined to the frame. Welding for a multilayer member is needed to perform welding at the portion where all these members overlap each other. When welding for a multilayer member is performed, it is difficult to secure sufficient weld strength. Accordingly, in order to avoid this welding, the respective members are shifted in a longitudinal direction in this vehicle body frame structure. As a result, the cross section of only one layer, that is, the floor frame is provided below a part of the floor panel. The cross section is apt to have low strength. Accordingly, the side portion of the reinforcing member extends to the cross section, so that the strength of the joining portion is secured.

### CITATION LIST

### Patent Literature

[Patent Literature 1] Unexamined Patent Application Publication No.-2006-290154

### SUMMARY OF INVENTION

### Technical Problem

In the vehicle body frame structure disclosed in Patent Literature 1, the front side frame extends forward from the joining portion that is joined to the floor frame. In addition, the front side frame is bent at a front end portion of a portion which extends forward so that the front side portion extends forward and upwards further than a portion which extends forward. The portion extending forward and upward is inclined to the longitudinal direction. When a load is input from the front of a vehicle at the time of a vehicle collision and a moment is generated at the side frame, an inclined portion is moved to rotate about a bent portion. In the vehicle body frame structure disclosed in Patent Literature 1, there is no scheme for improving yield strength against the moment on the bent portion. For this reason, a vehicle body frame structure, which can further improve yield strength against moment generated at the time of a vehicle collision, is desired.

Accordingly, an object of the invention is to provide a front side member structure that can improve yield strength against a moment generated due to a vehicle collision and the like.

### Solution to Problem

In order to solve the above-mentioned problem, according to the invention, there is provided a front side member structure that is provided at a lower portion of a vehicle so as to extend in a longitudinal direction of the vehicle and is used to form a frame of the vehicle. The front side member structure includes an under portion that extends in the longitudinal direction, and a kick portion that is provided at a front portion of the under portion and extends forward and upward. A front contour of the kick portion in the side view of the kick portion is inclined at an angle closer to a right angle than a rear contour of the kick portion in the side view of the kick portion.

In the invention, the front contour of the kick portion is inclined at an angle closer to a right angle than the rear contour of the kick portion. For this reason, in the front side member structure according to the invention, the cross section of a kick member is reduced at an upper portion of the kick member where a moment generated due to a vehicle collision and the like is small, and the cross section of the kick member is increased at a lower portion of the kick member where a generated moment is large. Accordingly, yield strength against a moment is increased at a portion where generated moment is large. Therefore, it is possible to improve yield strength against a moment generated due to a vehicle collision and the like.

Further, according to the invention, there is provided a front side member structure that is provided at a lower portion of a vehicle so as to extend in a longitudinal direction of the vehicle and is used to form a frame of the vehicle. The front side member structure includes an under member that extends in the longitudinal direction, and a kick member that is connected to a front portion of the under member and extends forward and upward. The under member and the kick member overlap each other at a connecting portion where the under member and the kick member are connected to each other.

In the invention, the under member, which extends in the longitudinal direction, and the kick member, which extends forward and upward, overlap each other at the connecting portion, so that the connecting portion is formed of two combined structures. Accordingly, yield strength against a moment at the connecting portion is increased. Therefore, it is possible to improve yield strength against a moment generated due to a vehicle collision and the like.

Furthermore, in an aspect, a front contour of the kick member in the side view of the kick member may be inclined at an angle closer to a right angle than a rear contour of the kick member in the side view of the kick member.

In this aspect, the front contour of the kick member is inclined at an angle closer to a right angle than the rear contour of the kick member. For this reason, in the front side member structure according to the invention, the cross section of a kick member is reduced at an upper portion of the kick member where a moment generated due to a vehicle collision and the like is small, and the cross section of the kick member is increased at a lower portion of the kick member where a generated moment is large. Accordingly, yield strength against a moment is increased at a portion where a generated moment is large. Therefore, it is possible to further improve yield strength against a moment generated due to a vehicle collision and the like.

Moreover, in an aspect, a back plate may be formed at a rear portion of the kick member.

In this aspect, a back plate is formed at a rear portion of the kick member and the back plate can receive a moment. For this reason, yield strength against a moment is increased. Accordingly, it is possible to further improve yield strength against a moment generated due to a vehicle collision and the like.

### Advantageous Effects of Invention

According to the invention, it is possible to provide a front side member structure that can improve yield strength against a moment generated due to a vehicle collision and the like.

### BRIEF DESCRIPTION OF DRAWINGS

FIG. 1 is a perspective view showing main parts of a front side member structure for a vehicle according to a first embodiment of the invention.

FIG. 2 is an exploded perspective view showing the main parts of the front side member structure shown in FIG. 1.

FIG. 3 is a side view showing a state where loads are input at the time of a head-on collision of a vehicle including the front side member structure shown in FIG. 1.

FIG. 4 is a graph showing a relationship between a moment input to the front side member structure and the bending yield strength of the front side member structure in the state shown in FIG. 3.

FIG. 5 is a perspective view showing main parts of a front side member structure for a vehicle according to a second embodiment of the invention.

FIG. 6 is a side view showing a state where loads are input at the time of a head-on collision of a vehicle including the front side member structure shown in FIG. 5.

### DESCRIPTION OF EMBODIMENTS

Embodiments of the invention will be described in detail below with reference to accompanying drawings. Meanwhile, the same elements in the description of the drawings are denoted by the same reference numerals, and the repeated description will be omitted.

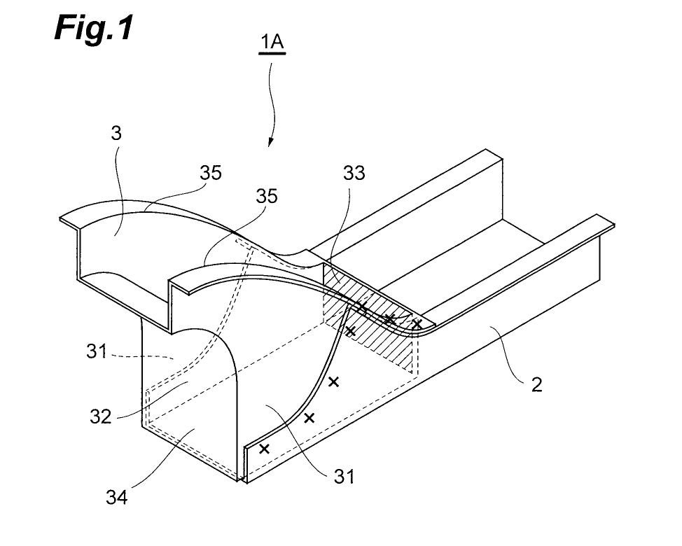

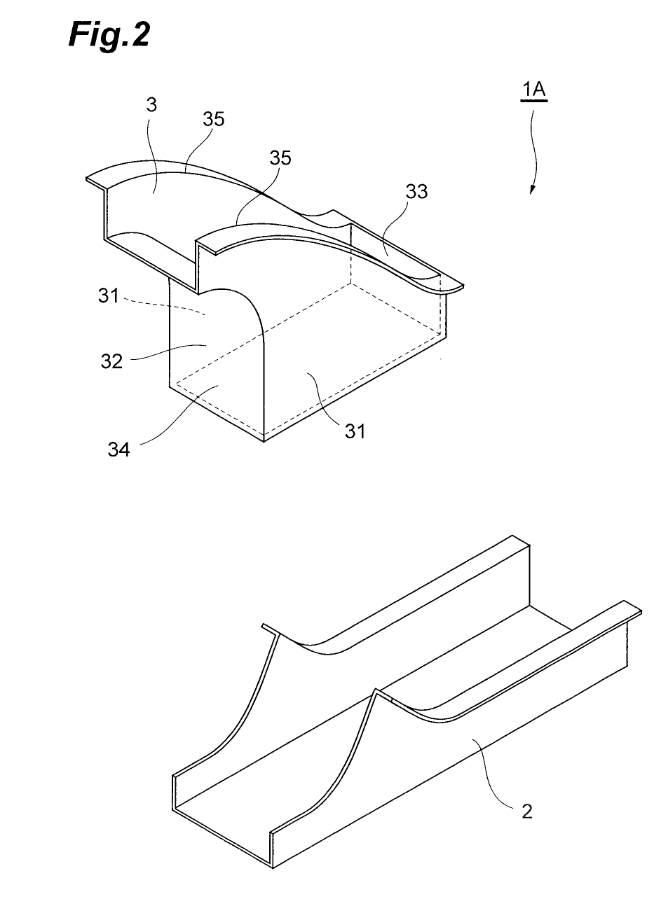

FIG. 1 is a perspective view showing main parts of a front side member structure for a vehicle according to a first embodiment of the invention. Further, FIG. 2 is an exploded perspective view showing the main parts of the front side member structure shown in FIG. 1.

A front side member structure 1A shown in FIG. 1 is a structure that is provided at the lower portion of a vehicle (not shown) so as to extend in the longitudinal direction of the vehicle. The front side member structure 1A is a structure that is used to form a frame of a vehicle and functions to absorb collision energy at the time of a head-on collision and the like of the vehicle. As shown in FIG. 1, the front side member structure 1A according to this embodiment includes an under member 2 and a kick member 3.

The under member 2 is a member that forms the rear portion of the front side member structure 1A, and extends in the longitudinal direction of the vehicle. The under member 2 has a substantially U-shaped cross section, and is disposed so as to have a cross section of which the upper portion is opened. Flanges, which face outside, are provided at upper end portions of the side portions of the under member 2 toward the rear side from the substantially middle portion of the under member 2 in the longitudinal direction.

The kick member 3 is a member that forms the front portion of the front side member structure 1A, and extends forward and upward. The kick member 3 is connected to the front portion of the under member 2. The kick member 3 has a substantially U-shaped cross section, and is disposed so as to have a cross section of which the upper portion is opened. Flanges, which face outside, are formed at upper end portions of the side portions of the kick member 3. The kick member 3 includes a pair of side plates 31 and 31, a front plate 32, and a back plate 33.

The pair of side plates 31 and 31 is portions that form the side portions of the kick member 3. An upper side 35 of the side plate 31 extends forward and upward. A front side of the side plate 31 extends forward and upward.

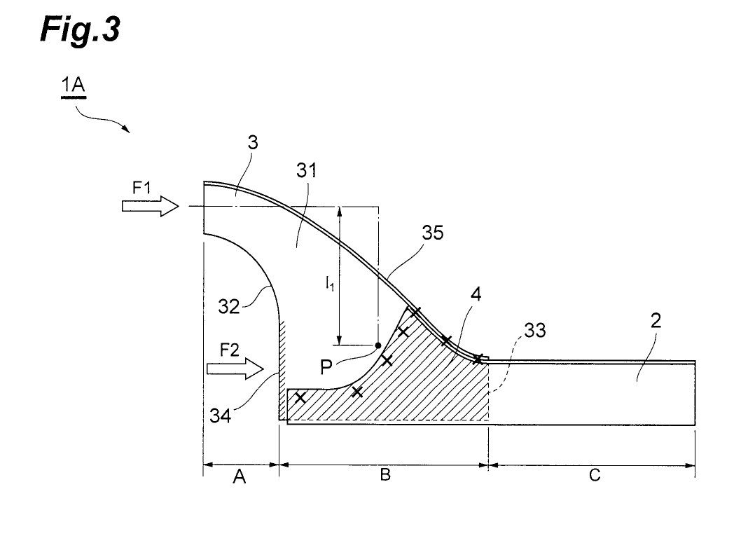

The front plate 32 is a portion that forms the front portion of the kick member 3. The front plate 32 is provided between the pair of side plates 31 and 31 along the front sides of the side plates 31, and connects the front sides. An abutment surface 34, which is a surface perpendicular to the longitudinal direction, is formed at a portion of the front plate 32, which forms a front contour in the side view of the kick member, below the upper end portion of the under member. Further, as shown in FIG. 3, the front plate 32, which forms a front contour in the side view of the kick portion, is inclined at an angle closer to a right angle than the upper side 35 of the side plate, which forms a rear contour in the side view of the kick portion. A suspension member (not shown) is provided in front of the abutment surface 34.

The back plate 33 is a portion that is formed at the rear portion of the kick member. The back plate 33 is provided between the pair of side plates 31 and 31 along the rear sides of the pair of side plates 31 and 31, and connects the rear sides of the pair of side plates 31 and 31.

A connecting portion 4, where the under member 2 and the kick member 3 are connected to each other, is formed of the front portion of the under member 2 and the rear portion of the kick member 3. The under member 2 and the kick member 3 overlap each other at the connecting portion 4. Connection is performed by, for example, spot welding. Here, marks x in FIG. 1 show spot welding points. The spot welding points may be positioned in a range where, for example, the flanges of the under member 2 and the flanges of the kick member 3 overlap each other.

As described above, the front side member structure 1A according to this embodiment is formed so as to be divided into the under member 2 and the kick member 3. Accordingly, the front side member structure is easily formed and manufactured as compared to a case where the front side member structure is formed of one member.

Next, the operations and effects of the front side member structure according to this embodiment will be described.

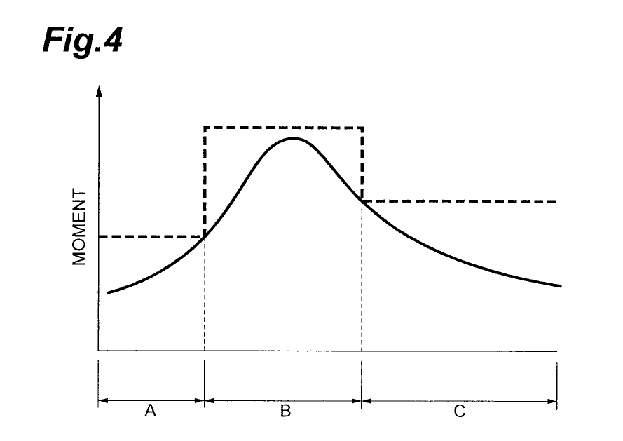

FIG. 3 is a side view showing a state where loads are input at the time of a head-on collision of a vehicle including the front side member structure shown in FIG. 1. Further, FIG. 4 is a graph showing a relationship between a moment input to the front side member structure and the bending yield strength of the front side member structure in the state shown in FIG. 3. A solid line of FIG. 4 shows a moment that is to be input to each portion of the front side member structure by a collision, and a broken line shows the bending yield strength of each portion of the front side member structure.

The bending yield strength of each portion of the front side member structure shown by a broken line of FIG. 4 will be described here. A front area A shown in FIGS. 3 and 4 represents an area in front of the abutment surface 34. Further, an overlap area B represents an area of the connecting portion 4 where the under member 2 and the kick member 3 overlap each other. Furthermore, a rear area C represents an area behind the back plate 33.

Since the front side member structure 1A has a small cross section and is formed of only the kick member 3 at the front area A, the bending yield strength of the front side member structure is the lowest as shown by a broken line of FIG. 4. Meanwhile, since the front side member structure 1A has a large cross section and is formed of two combined members, that is, the under member 2 and the kick member 3 overlapping each other at the overlap area B, the bending yield strength of the front side member structure is the highest. Further, the front side member structure 1A has a small cross section and is formed of only the under member 2 at the rear area C but the back plate 33 receives a moment, so that the yield strength of the front side member structure is higher at the rear area than the front area A.

Next, the moment to be input to each portion of the front side member structure, which is shown by a solid line of FIG. 4, will be described. As shown in FIG. 3, a load (hereinafter, referred to as a “first load F1”) from a bumper (not shown) is input to the kick member 3 at the time of a head-on collision of a vehicle. When the first load F1 is input to the kick member, the kick member 3 is moved to rotate about a bent portion of the front side member structure 1A, that is, at one point in the range of the connecting portion 4 as a center. At this time, a moment is input to each portion of the front side member structure 1A as shown by a solid line of FIG. 4. The intensity of the moment is obtained by the product of the first load F1 and a distance between the input position of the first load F1 and each portion in a vertical direction. For example, a maximum moment M1 is input to the position of a centroid P, which is positioned in the range of the connecting portion, and a value of the maximum moment M1 is represented by “F1×11”. Here, 11 denotes a distance between the input position of the first load F1 and the centroid P in the vertical direction.

As shown in FIG. 3, a distance between the input position of the first load F1 and each portion is small at the front area A. Accordingly, a moment input to the front area is small as shown by a solid line of FIG. 4. Accordingly, even though bending yield strength of the front side member structure is low, the front side member structure can receive a moment.

Meanwhile, a distance between the input position of the first load F1 and each portion is large at the overlap area B. Accordingly, a moment input to the overlap area is large. However, the bending yield strength of the front side member structure 1A according to this embodiment is increased at the overlap area B as described above. Accordingly, even though a large moment is input to the front side member structure, the front side member structure can receive a moment.

A distance between the input position of the first load F1 and each portion is large at the rear area C but a moment is attenuated while being transmitted to the rear area. Accordingly, a moment as large as the moment input to the overlap area B is not input to the rear area C. Therefore, even though the bending yield strength of the front side member structure is not as high as the bending yield strength at the overlap area B, the front side member structure can receive a moment. It is possible to improve yield strength against a moment, which is generated due to a vehicle collision and the like, by disposing an appropriate member at each portion according to a moment, which is to be input, as described above.

Moreover, in the front side member structure 1A according to this embodiment, a load is transmitted to the under member 2, which is positioned at the rear, through not only the front plate 32, the side plates 31, and the bottom of the kick member 3 but also the back plate 33. Accordingly, a load is easily transmitted to a member that is positioned at the rear.

Next, a load (hereinafter, referred to as a “second load F2”), which is input from a suspension member at the time of a head-on collision of a vehicle and the like, will be described. In the front side member structure 1A according to this embodiment, the second load F2 is input to the abutment surface 34. Here, the input direction of the second load F2 is a longitudinal direction, and the abutment surface 34 is a surface perpendicular to the longitudinal direction. Accordingly, the front side member structure 1A according to this embodiment can receive the second load F2 so that the second load is perpendicular to the front side member structure. Therefore, the front side member structure is adapted to easily receive a load, which is generated due to a vehicle collision and the like, from the front.

Further, the connecting portion 4 includes an edge line that is formed by the bottom side of the side plate 31 and an edge line that is formed by the rear side of the side plate 31. Accordingly, the second load F2 is transmitted to a member, which is positioned at the rear, through these two edge lines. Therefore, the second load is efficiently transmitted to the member that is positioned at the rear. In addition, the lower portion of the connecting portion 4 is formed of two combined portions, that is, the bottom of the under member 2 and the bottom of the kick member 3. Accordingly, it is not necessary to set a separate component such as a patch, so that it is possible to prevent the increase of the number of components.

Further, the rear portion of the abutment surface 34 is formed of the bottom of the under member 2 and the bottom of the kick member 3 so as to be straight in a horizontal direction. Accordingly, since the second load F2 is received straight, it is possible to prevent a moment from being generated by the second load F2. Furthermore, since the input second load F2 is attenuated while being transmitted to the rear portion of the front side member structure 1A, that is, the rear portion of the under member 2, the input second load is reduced at the rear portion of the front side member structure. Accordingly, since the rear portion of the under member 2 can be formed of one piece, it is possible to improve the mass efficiency of the entire front side member structure 1A.

As described above, according to the front side member structure 1A of this embodiment, it is possible to improve yield strength against a moment that is generated due to a vehicle collision and the like.

Next, a front side member structure for a vehicle according to a second embodiment of the invention will be described below.

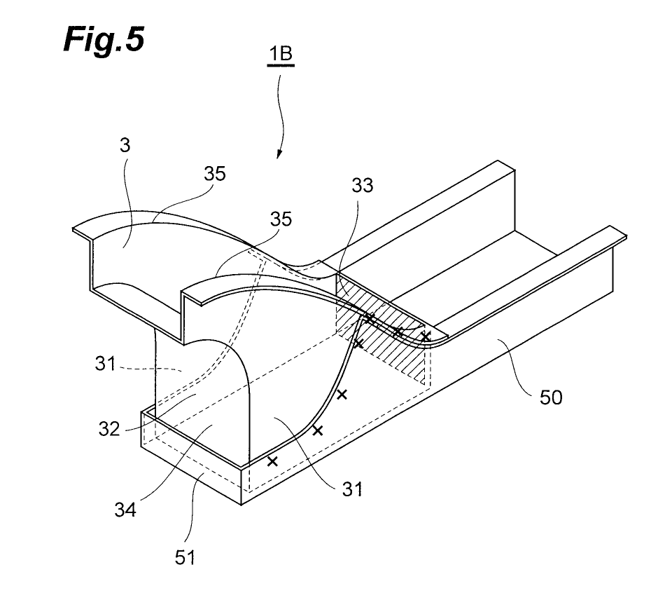

FIG. 5 is a perspective view showing main parts of a front side member structure for a vehicle according to a second embodiment of the invention. A front side member structure 1B according to this embodiment is different from the front side member structure 1A according to the first embodiment in that an under member 50 is provided with a lower front plate 51, and is otherwise the same as the front side member structure 1A according to the first embodiment. The lower front plate 51 is a portion that forms a front portion of the under member 50. The lower front plate 51 forms a surface perpendicular to the longitudinal direction.

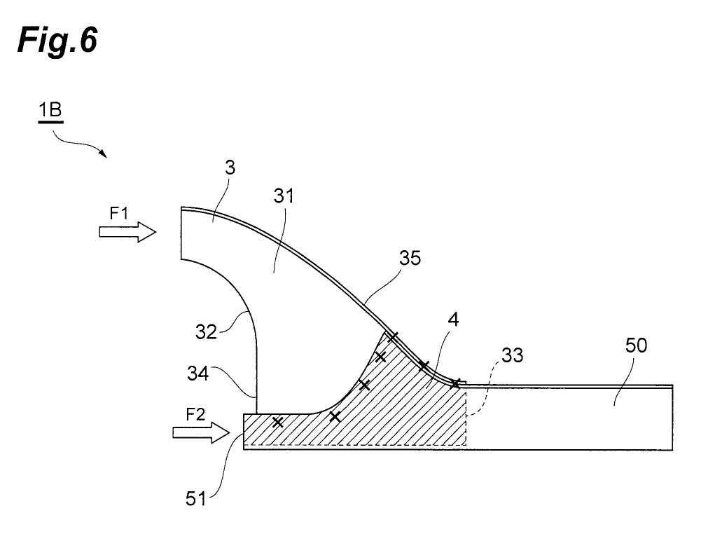

FIG. 6 is a side view showing a state where loads are input at the time of a head-on collision of a vehicle including the front side member structure shown in FIG. 5. In the front side member structure 1B according to this embodiment, the lower front plate 51 receives a second load F2 as shown in FIG. 6. Here, the input direction of the second load F2 is a longitudinal direction, and the lower front plate 51 forms a surface perpendicular to the longitudinal direction. Accordingly, the front side member structure according to this embodiment can receive the second load F2 so that the second load is perpendicular to the front side member structure. Therefore, the front side member structure is adapted to easily receive a load. Further, in the front side member structure 1B according to this embodiment, the lower front plate 51 of the under member 50 receives the second load F2, which does not pass through the kick member 3. Accordingly, the front side member structure 1B according to this embodiment is adapted to be capable of more reliably receiving the second load F2 than the first embodiment.

As described above, according to the front side member structure 1B of this embodiment, it is possible to further reliably receive a load, which is generated due to a vehicle collision and the like, from the front as compared to the front side member structure 1A according to the first embodiment.

Meanwhile, the above-mentioned embodiments are examples of the front side member structure according to the invention. For this reason, the front side member structure according to the invention is not limited to the above-mentioned embodiments.

For example, in the above-mentioned embodiments, the front side member structure includes the under member and the kick member that is a member independent of the under member, but may be formed of one member. In this case, a part of the member functions as an under portion and the other part thereof functions as a kick portion.

### INDUSTRIAL APPLICABILITY

According to the invention, it is possible to improve yield strength against a moment that is generated due to a vehicle collision and the like.

### REFERENCE SIGNS LIST

1A, 1B: front side member structure

2, 50: under member

3: kick member

4: connecting portion

32: front plate

33: back plate

35: upper side

1. A front side member structure for a vehicle that is provided at a lower portion of a vehicle so as to extend in a longitudinal direction of the vehicle and is used to form a frame of the vehicle, the front side member structure comprising:
an under portion that extends in the longitudinal direction; and
a kick portion that is provided at a front portion of the under portion and extends forward and upward,
wherein a front contour of the kick portion in the side view of the kick portion is inclined at an angle closer to a right angle than a rear contour of the kick portion in the side view of the kick portion, and
an abutment surface, which is a surface perpendicular to the longitudinal direction, is formed at a portion, which forms a front contour in the side view of the kick portion, below an upper end portion of the under portion.

2. A front side member structure for a vehicle that is provided at a lower portion of a vehicle so as to extend in a longitudinal direction of the vehicle and is used to form a frame of the vehicle, the front side member structure comprising:
an under member that extends in the longitudinal direction; and
a kick member that is connected to a front portion of the under member and extends forward and upward,
wherein the under member and the kick member overlap each other at a connecting portion where the under member and the kick member are connected to each other,
a front contour of the kick member in the side view of the kick member is inclined at an angle closer to a right angle than a rear contour of the kick member in the side view of the kick member, and
an abutment surface, which is a surface perpendicular to the longitudinal direction, is formed at a portion, which forms a front contour in the side view of the kick member, below an upper end portion of the under member.

3. (canceled)

4. The front side member structure for a vehicle according to claim 2,
wherein a back plate is formed at a rear portion of the kick member.
